(19) United States
(12) Patent Application Publication
(10) Pub. No.: US 2007/0002077 A1
(43) Pub. Date: Jan. 4, 2007

(54) Methods and System for Providing Information Services Related to Visual Imagery Using Cameraphones

(76) Inventor: Kumar C. Gopalakrishnan, Mountain View, CA (US)

Correspondence Address: Kumar C. Gopalakrishnan, P.O. Box 2002, Mountain View, CA, 94042, US

(21) Appl. No.: 11/530,449

(22) Filed: Sep. 8, 2006

Related U.S. Application Data
(63) Continuation-in-part of application No. 11/215,601, filed on Aug. 30, 2005.
(60) Provisional application No. 60/715,529, filed on Sep. 9, 2005.
(60) Provisional application No. 60/606,282, filed on Aug. 31, 2004.

(51) Int. Cl. G09G 5/00

(52) U.S. Cl. 345/619

(57) ABSTRACT

A system and methods for providing information services related to visual imagery using cameraphones is presented. Operational details of the various methods used to operate the system are also described. The methods enable the capture of visual imagery, the request and presentation of information services related to the visual imagery.

### CROSS-REFERENCE TO RELATED APPLICATIONS

This application claims the benefit of U.S. provisional patent application 60/715,529, filed Sep. 9, 2005, and is a continuation-in-part of U.S. patent application Ser. No. 11/215,601, filed Aug. 30, 2005, which claims the benefit of U.S. provisional patent application 60/606,282, filed Aug. 31, 2004. These applications are incorporated by reference along with all other references cited in this application.

### BACKGROUND OF THE INVENTION

The present invention is related to providing information services related to visual imagery. More specifically, the invention describes methods for providing information services related to visual imagery using cameraphones.

Systems for providing information services on mobile phones exist. However, a mechanism for providing information services related to visual imagery using cameraphones is in need.

### BRIEF SUMMARY OF THE INVENTION

The present invention describes a system and methods for providing information services related to visual imagery using cameraphones. The system and methods enable the providing of a user experience for requesting, presenting, and interacting with the information services.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1(a) illustrates the components of the system, in accordance with an embodiment.

FIG. 1(b) illustrates the components of a cameraphone, in accordance with an embodiment.

FIG. 1(c) illustrates the components of an alternate view of a cameraphone, in accordance with an embodiment.

FIG. 2(a) illustrates an exemplary login view, in accordance with an embodiment.

FIG. 2(b) illustrates an exemplary menu widget, in accordance with an embodiment.

FIG. 2(c) illustrates an exemplary camera view, in accordance with an embodiment.

FIG. 2(d) illustrates an alternate exemplary camera view, in accordance with an embodiment.

FIG. 2(e) illustrates an exemplary view for inputting textual information, in accordance with an embodiment.

FIG. 2(f) illustrates an exemplary help view, in accordance with an embodiment.

FIG. 2(g) illustrates an exemplary transient information view, in accordance with an embodiment.

FIG. 2(h) illustrates an exemplary index view, in accordance with an embodiment.

FIG. 2(i) illustrates an alternate exemplary index view, in accordance with an embodiment.

FIG. 2(j) illustrates an exemplary content view, in accordance with an embodiment.

FIG. 2(k) illustrates an alternate exemplary content view, in accordance with an embodiment.

FIG. 3(a) illustrates an exemplary process for requesting information services related to visual imagery using a one-step mode of operation, in accordance with an embodiment.

FIG. 3(b) illustrates an exemplary process for requesting information services related to visual imagery using a two-step mode of operation, in accordance with an embodiment.

FIG. 3(c) illustrates an exemplary process for requesting information services related to visual imagery using a three-step mode of operation, in accordance with an embodiment.

FIG. 3(d) illustrates an exemplary process for requesting information services related to visual imagery using a zero-input mode of operation, in accordance with an embodiment.

FIG. 4 is a block diagram illustrating an exemplary computer system suitable for providing information services related to visual imagery, in accordance with an embodiment.

### DETAILED DESCRIPTION OF THE INVENTION

A system and methods are described for providing information services related to visual imagery using cameraphones. Various embodiments present mechanisms for providing information services related to visual imagery. The specific embodiments described in this description represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” or “some embodiments” means that a particular feature, structure, or characteristic described in connection with the embodiment is included in at least one embodiment of the invention. The appearances of the phrase “in one embodiment” or “some embodiments” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

Various embodiments may be implemented in a computer system as software, hardware, firmware, or a combination of these. Also, an embodiment may be implemented either in a single monolithic computer system or over a distributed system of computers interconnected by a communication network. While the description below presents the full functionality of the invention, the mechanisms presented in the invention are configurable to the capabilities of the cameraphone and associated computer systems on which it is implemented, the resources available in the cameraphone and associated computer systems and the requirements for providing information services related to visual imagery.

In the context of this description, the term “system” refers to a system that provides information services related to visual imagery including a cameraphone.

In the context of this description, the term “information service” is used to refer to a user experience provided by the system that may include the logic to present the user experience, multimedia content used to provide the user experience, and related user interfaces. The term “content” is used to refer to multimedia data used in the information services. Content included in an information service may be in text, audio, video or graphical formats. For example, an information service may be comprised of text. Another exemplary information service may be comprised of text, video and associated controls for playing the video information. In some embodiments, information services may include information retrieved from various sources such as Web sites, Web search engines, news agencies, e-commerce storefronts, comparison shopping engines, entertainment content, games, and the like. In other embodiments, the information services may modify or add new components (e.g., software applications, ring tones, contact information) to the cameraphone on which the user interface is implemented.

In the context of this description, the term “visual imagery” refers to a single still image, a plurality of still images, a single video sequence, a plurality of video sequences or combinations thereof. Visual imagery may also include associated metadata such as capture device characteristics, file format characteristics, audio, tags, time of capture, location of capture, author name, filename, and the like. In the context of this description, the term “visual element” refers to text, numbers, icons, symbols, pictograms, ideograms, graphical primitives, and other such elements in a visual imagery and their layout and formatting information in the visual imagery.

In the context of this description, the term “user interface element” refers to icons, text boxes, menus, graphical buttons, check boxes, sounds, animations, lists, and the like that constitute a user interface. The terms “widget” and “control” are also used to refer to user interface elements. In the context of this description, the term “input component” refers to a component integrated into the system such as a key, button, joystick, touch pad, motion sensing device, speech input, and the like that can be used to input information to the user interface. In the context of this description, the term “cursor control component” refers to a component integrated into the system such as a key, button, joystick, touch pad, motion sensing device, speech input, and the like that can be used to control a cursor on the user interface. In the context of this description, the term “navigational component” refers to a component integrated into the system such as a key, button, joystick, touch pad, motion sensing device, speech input, and the like that can be used to select, control, and switch between various user interface elements. In the context of this description, the term “menu command” refers to a command associated a menu item on the user interface.

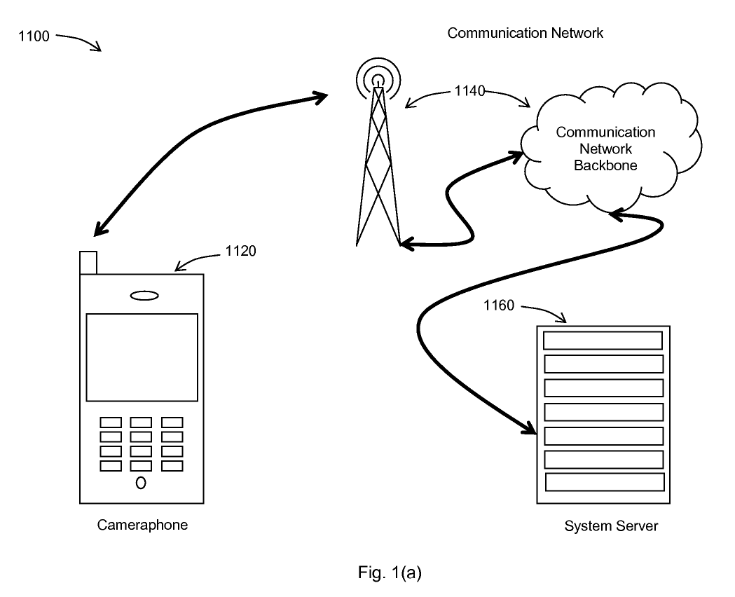

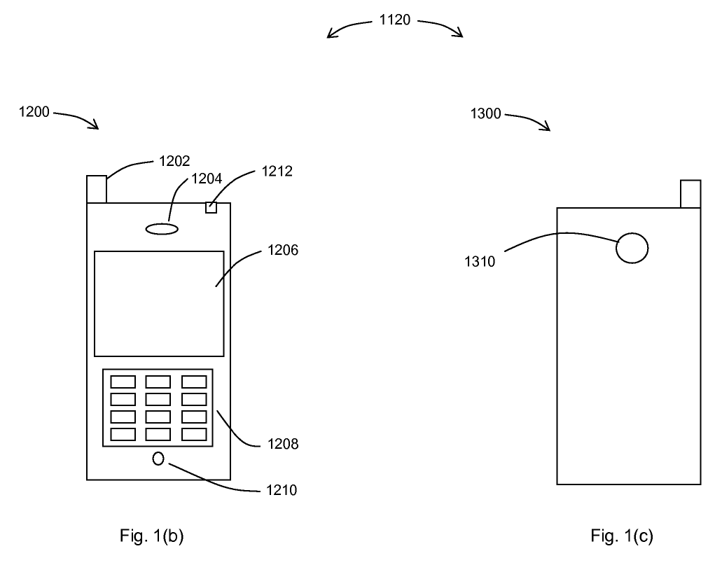

FIG. 1(a) illustrates the components of exemplary system 1100 comprised of cameraphone 1120, system server 1160 and communication network 1140 connecting the cameraphone and system server.

FIGS. 1(b) and 1(c) illustrate the components of an exemplary cameraphone 1120 on which information services related to visual imagery may be provided. Front view of cameraphone 1200 illustrated in FIG. 1(b) shows the communication antenna 1202, speaker 1204, display 1206, keypad 1208, microphone 1210 and visual indicator (e.g., LED) 1212. Rear view of cameraphone 1300 illustrated in FIG. 1(c) shows the integrated camera 1310. In some embodiments, cameraphone 1120 may include other input components such as a joystick, thumbwheel, scroll wheel, touch sensitive panel, touch sensitive display, or additional keys.

Exemplary User Interface Architecture

The user interface for accessing, presenting, and interacting with information services related to visual imagery on the cameraphone 1120 may be comprised of both visual and audio components. Visual components of the user interface may be presented on display 1206 and the audio components on speaker 1204. User inputs may be acquired by the system through camera 1310, microphone 1210, keypad 1208, and other input components integrated into cameraphone 1120. In some embodiments, the user interface may be presented using a plurality of devices that together provide the functionality of cameraphone 1120. For instance, visual components of the user interface may be presented on a television set while user inputs are obtained from a television remote control.

The visual component of the user interface may include a plurality of visual representations herein termed as “views.” Each view may be configured to address the needs of a specific set of functions of the system as further described.

A “login view” may enable authentication to the system. A “camera view” may enable capture of visual imagery and include a viewfinder to present visual imagery. In some embodiments, the viewfinder may encompass the entire camera view.

Information services may be presented in “index” and “content” views. An index view may be used to present one or more information services. A user may browse through the available set of information service options presented in an index view and select one or more information services to be presented in a content view or using components external to the system (e.g., a web browser). The information services presented in the index view may have a compact representation to optimize the use of the display area. The content view may be used to present an information service in its full form.

Help information related to the system may be presented in a “help view.” In addition, transient information services may be presented in a “transient information view.” The user may also interact with the views using various control widgets embedded in the information service, controls such as menu commands integrated into the user interface and appropriate input components integrated into cameraphone 1120.

The views described here may include controls for controlling the presentation of information in audio or video format. The controls may enable features such as play, pause, stop, forward, and reverse of the audio or video information. Audio information may be presented through speaker 1204 or other audio output component connected to the system.

In some embodiments, the user interface and its functionality may be integrated as a single entity in the system. For example, the user interface may be implemented by a software application (e.g., in environments like J2ME, Symbian, and the like) that is part of the system. In other embodiments, some components of the user interface and their functionality may be implemented by various components integrated into the system. For example, the camera view may be integrated into a camera software application or the index and content views may be integrated into a World Wide Web browser.

In some embodiments, the user interface views may also incorporate elements for presenting various system statuses. If the system is busy processing or communicating information, the busy status may be indicated by a graphical representation of a flashing light 2120. In other embodiments, the busy status may be represented differently. For example, the progress of a system activity over an extended duration of time may be indicated using progress bar 2140. A fraction of progress bar 2140, proportionate to the fraction of the extended duration activity completed, may change color to indicate the progress of the operation. Information may also be presented in auxiliary or status panes in textual and graphical form.

Further, in some embodiments, the user may be aided in navigating between the different views through use of user interface elements. For example, the different views may be represented in the form of a tabbed panel 2118, wherein various tabs represent different views in the user interface. In some embodiments, the views may be presented as windows that may overlap to various extents.

The views described here may include controls for controlling the presentation of information in audio or video format. The controls may enable features such as play, pause, stop, forward and reverse of the audio or video information. Audio information is presented through speaker 1204 or other audio output component connected to the system. System status indicators, tabbed panels and windows may also be incorporated in any of the views described.

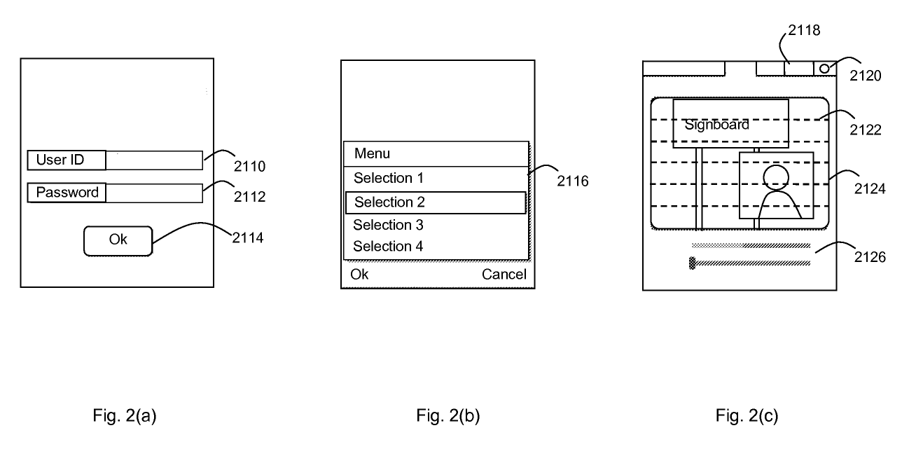

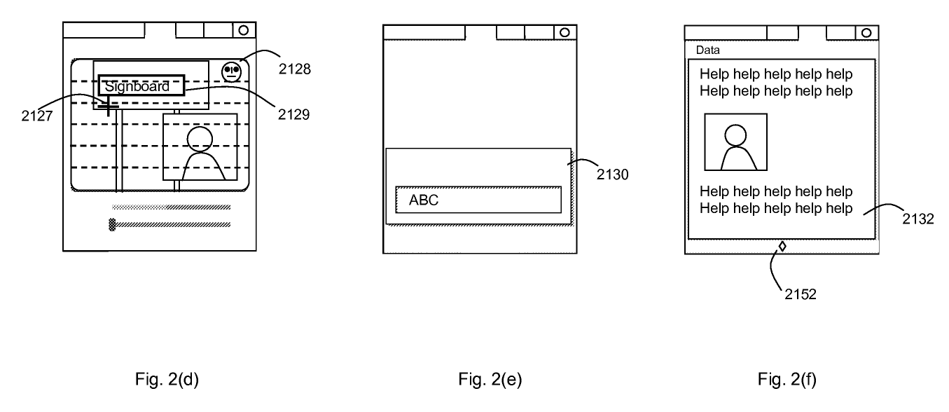

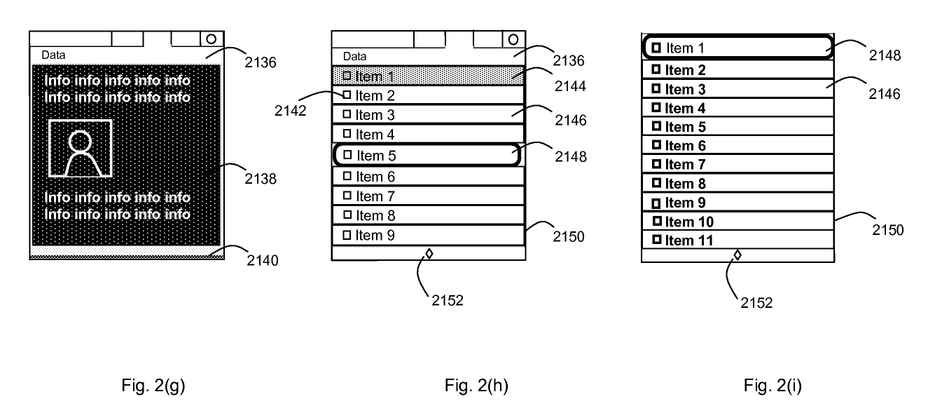

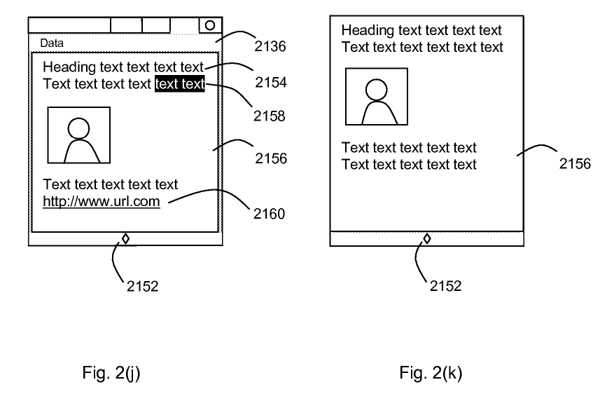

FIG. 2(a) illustrates an exemplary view of the user interface for user authentication referred to herein as the “login view”. Here, a user can type in an alphanumeric user identifier 2110 and password 2112 into text boxes using a text input device (e.g., keypad) integrated into cameraphone 1120. The user may then initiate the authentication process by highlighting a graphical button 2114 on the user interface and clicking on a joystick or other similar input component on cameraphone 1120. In other embodiments, other inputs such as user's speech, user's voice, user's biometric identify (e.g., visual imagery of user's face, fingerprint or palm) or other unique identifiers may be used for authenticating the user. In such embodiments, the login view includes appropriate controls for capturing the authentication information. In some embodiments, the login view may not be present.

FIG. 2(b) illustrates an exemplary menu widget used in the user interface as used in some embodiments. Any of the views described may include appropriate menus for the triggering various commands and functionality of the system. The menu may be navigated using a joystick or other appropriate menu navigation input component integrated into cameraphone 1120.

FIG. 2(c) illustrates an exemplary view of the user interface for displaying visual imagery referred herein as the “camera view” as used in some embodiments. Here, a user may view visual imagery using viewfinder 2124. In some embodiments, the visual imagery is sourced live from camera 1310 integrated into cameraphone 1120. In other embodiments, the visual imagery is sourced from pre-recorded stored visual imagery. FIG. 2(c) also illustrates reference marks such as horizontal lines 2122 that may be present in some embodiments. In some embodiments, reference marks 2122 are used to aid the aligning and sizing the visual imagery on viewfinder 2124. In some embodiments, the visual imagery may be aligned with the reference marks 2122 through physical motion and rotation of camera 1310 relative to the scene being imaged. In some embodiments, the visual imagery may be aligned with the reference marks 2122 through use of zoom and rotation controls integrated into cameraphone 1120 or the system. In some embodiments, the visual imagery may be aligned as per system requirements by the system itself through analysis of the visual imagery. In some embodiments, the camera view may include the capability to present a plurality of still images or video (e.g., in the form of a gallery or filmstrip).

The camera view may optionally include controls that indicate the status of the system and characteristics of the visual imagery. For example, in some embodiments, system status (e.g., camera zoom level) and visual imagery characteristics (e.g., brightness of visual imagery) may be indicated by other optional controls on the user interface 2126. In some embodiments, controls for adjusting zoom level, macro mode, focus and the like may be integrated in the user interface 2126.

FIG. 2(d) illustrates an exemplary camera view of the user interface depicting regions of significance, as used in some embodiments. Here, the text “Signboard” in the visual imagery has been highlighted by the rectangle 2129. In other embodiments, a region of significance may be depicted through other textual and graphical marks a (e.g., change in color, underlining, flashing). In some embodiments, such regions of significance may be generated by the system. In some embodiments, such regions of significance may be drawn by the user using appropriate drawing tools. For example, a user may use a cursor on the user interface 2127 in conjunction with cursor control keys or a joystick to draw the regions of significance. In such an embodiment, additional user inputs may be required to start the use of the drawing tools and to stop using them. In some embodiments, icons and other graphical marks 2128 may also be used to represent regions of significance in the visual imagery graphically.

FIG. 2(e) illustrates an exemplary view of the user interface for inputting textual information, as used in some embodiments. Textual information may be input using keypad 1208 or other text input components integrated into cameraphone 1120. The textual information may optionally be displayed in a text box 2130. In some embodiments, the textual information may be used to request and present related information services.

FIG. 2(f) illustrates an exemplary view of the user interface for presenting help information herein referred to as the “help view” as used in some embodiments. Help information educates users on the features of the system. The help information includes textual and graphical information and is presented on a pane 2132 that can optionally be navigated using navigation keys, a joystick or other similar input component integrated into cameraphone 1120. Scroll indicators 2152 provide visual feedback on the portion of the help information displayed to aid in the navigation of the help information. Help information may be presented in textual, graphical, video or other multimedia formats. In some embodiments, the help view may integrate few controls other than the help view illustrated in FIG. 2(f) to maximize the use of the display area for presenting the help information. In some embodiments, the help information pane may occupy the entire display area.

FIG. 2(g) illustrates an exemplary view of the user interface for presenting transient information services herein referred to as “transient information view”, as used in some embodiments. Here, the transient information in textual, graphical, video or other multimedia format is presented on the transient information services pane 2138.

FIG. 2(g) also illustrates progress bar 2140 which may be used to depict the progress of any extended activity in the system as described earlier. FIG. 2(g) also illustrates auxiliary pane 2136 which presents information related to various system parameters, other widgets in the user interface and information derived from information services presented in the views. Auxiliary pane 2136 may be used with any of the views in the user interface. In some embodiments, auxiliary pane 2136 may be located in positions other than as illustrated in FIG. 2(g). In some embodiments, auxiliary pane 2136 may be overlaid on top of other user interface widgets. In FIG. 2(g), auxiliary pane 2136 presents a status message “Data”

In some embodiments, the user interface may employ a lighter color (e.g., white) for presenting information against a dark color (e.g., black) background. Such a color scheme is especially useful while presenting information services on a backlit LCD display. FIG. 2(g) illustrates such a representation of transient information. Such color schemes may also be used for other views used in the user interface.

FIG. 2(h) illustrates an exemplary view of the user interface for presenting a set of information services herein referred to as the “index view”, as used in some embodiments. Here, the set of information services may be presented as list 2150 wherein each item in the list has an icon 2142 and textual information 2146. Icon 2142 may be used to represent various metadata associated with each item in the list (e.g., source of information services, category of information services, media type used in information services, etc.). Icon 2142 may also provide a thumbnail view of visual content included in the information service.

In the embodiment illustrated in FIG. 2(h), each item in list 2150 has a single icon associated with it. In other embodiments, information associated with each item may be represented by additional graphical information (e.g., icons), additional textual information, special emphasis on textual information (e.g., bold text), audio signals (i.e., sounds) or video or animated visual icons. Examples of information that may be associated with items in the list include the commercial or sponsored nature of information services, the fee for accessing commercial information services, the access rights for the information services, source of the information services, the spatial, temporal and geographical location of information services, the spatial, temporal and geographical availability of information services, the nature of the information services in terms of the multimedia types such as audio or video used in the information services and the nature of the information services in terms of the adult or mature content used in the information services are represented.

In some embodiments, the information services may be presented in a compact form to maximize use of the display space for presenting the information services. Compact representation of an information service may involve the use of a subset of the information available in an information service. For example, a compact representation may show only the title text of an information service. Audio information may be presented through speaker 1204 integrated into cameraphone 1120.

In some embodiments, items in the list may be selected using cursor 2148. In addition, in some embodiments, the items that were previously selected may be depicted with a representation that differs from items that have not been selected. For example, in FIG. 2(h), previously selected item 2144 is shown with a different (i.e., gray) background color while unselected items 2146 are shown with the default (i.e., white) background color.

Information related to the items in the list may also be presented in auxiliary pane 2136 described earlier. For example, price of a book, URL of a web site, WWW domain name, source of a news item, type of a product, time and location associated with an information service, etc. may be presented in auxiliary pane 2136. In addition, as a user moves cursor 2148, auxiliary pane 2136 may be updated to display metadata related to the item currently highlighted by cursor 2148. In some embodiments, a short clip of the audio information associated with an information service may be played as preview when an item in the list is selected.

In some embodiments, the index view may also include controls for controlling presentation when presenting information in audio or video format. The controls may enable features such as play, pause, stop, forward and reverse of the audio or video information. Audio information may be presented through speaker 1204 integrated into cameraphone 1120. The scroll indicators 2152 serve to guide the navigation of the help information as described earlier. In some embodiments, information that share common attributes (e.g., information sourced from World Wide Web) may be represented using shared attributes such as a common icon, text color or background color.

In some embodiments, the index view may employ a lighter color (e.g., white) for presenting information against a dark color (e.g., black) background. Such a color scheme is especially useful while presenting information services on a backlit LCD display.

FIG. 2(i) illustrates an exemplary view of the user interface for presenting a set of information services herein referred to as the “index view” as used in some embodiments. Here, the index view integrates fewer controls compared to the view illustrated in FIG. 2(h) to maximize the use of the display area for presenting the list of information services. In some embodiments, the list may occupy the entire display area. Other functionality of this alternate representation of the index view are similar to the index view illustrated in FIG. 2(h).

FIG. 2(j) illustrates an exemplary view of the user interface for presenting information services herein referred to as the “content view”, as used in some embodiments. Here, the visual component of an information service is presented in content pane 2156. Information services presented on content pane 2156 may include information in text, image and video formats. Audio information may be presented through speaker 1204 integrated into cameraphone 1120. In some embodiments, the content view may also include controls for controlling presentation when presenting information in audio or video format. The controls may enable features such as play, pause, stop, forward and reverse of the audio or video information. The information service presented in content pane 2156 may also include formatting such as a heading 2154. Other information associated with the information service may also be presented in auxiliary pane 2136. The scroll indicators 2152 serve to guide the navigation of the information presented as described earlier.

In some embodiments, parts of the information presented may be identified as significant. For instance, here, text of significance is highlighted 2158. In other embodiments, a region of significance may be depicted through other textual and graphical marks a (e.g., change in color, underlining, flashing). A graphical cursor may be used in conjunction with cursor control keys, joystick or other similar input components to highlight presented information. In FIG. 2(j), text is shown highlighted with a black background 2158. In other embodiments, significant information may be depicted through the use of special graphical elements (e.g., icons, etc.) or use of other emphasis on text (e.g., underline, bold vs. regular typeset). Further, hyperlinks such as 2160 may be embedded in the content to request additional information associated with the information service presented. The additional information services accessed using the hyperlink may either be presented using the user interface (e.g., index view or content view) or using components external to the system (e.g., a web browser).

In some embodiments, the content view may employ a lighter color (e.g., white) for presenting information against a dark color (e.g., black) background. Such a color scheme is especially useful while presenting information services on a backlit LCD display.

FIG. 2(k) illustrates an exemplary view of the user interface for presenting information services herein referred to as the “content view”, as used in some embodiments. Here, the content view integrates fewer controls compared to the view illustrated in FIG. 2(j) to maximize the use of the display area for presenting the information service. Other functionality of this view is similar to the view illustrated in FIG. 2(j).

The user interface may also allow customization. Such customizations of user interfaces are commonly referred to as themes or skins. The customization may be either specified explicitly by the user or determined automatically by the system based on criteria such as system and environmental factors. System factors used by the system for customizing the user interface include the capabilities of cameraphone 1120, the capabilities of the communication network, the system learned preferences of the user and the media formats used in the information services being presented. Another system factor used for the customization may be the availability of sponsors for customization of the user interface. Sponsors may customize the user interface with their branding collateral and advertisement content. Environmental factors used by the system for customizing the user interface may include the geographical and spatial location, the time of day of use and the ambient lighting. User interface options that are thus customized may include color schemes, icons used in the user interface, the layout of the widgets in the user interface and commands assigned to various functions of the user interface.

The user interface may enable communication information presented in the views using communication services such as email, SMS, MMS and the like. For instance, the list of information presented in the index view or the information service presented in detail in the content view may be communicated to a recipient as an email using appropriate menu commands or by activating appropriate graphical user interface widgets.

The user interface may also enable storage information services presented in the views. For instance, the list of information services presented in the index view or the information service presented in detail in the content view may be stored for later access and use, using appropriate menu commands or by activating appropriate graphical user interface widgets.

User Interface Input Mechanisms

In the context of this description, the term “click” refers to an user input on the user interface wherein, the user clicks on a key, button, joystick, scroll wheel, thumb wheel or equivalent integrated into cameraphone 1120, the user flicks a joystick integrated into cameraphone 1120, the user spins or clicks a scroll wheel, thumb wheel or equivalent, or the user taps on a touch sensitive or pressure sensitive input component. In the context of this description, the term “flick” refers to a movement of a joystick, scroll wheel, or thumb wheel in one of its directions of motion.

In addition, in the context of this description, the term “click” may refer to 1) the transitioning of an input component from its default state to a selected or clicked state (e.g. key press), 2) the transitioning of an input component from its selected or clicked state to its default state (e.g. key release) or 3) the transitioning of an input component from its default state to a selected or clicked state followed by its transitioning back from the selected or clicked state to its default state (e.g. key press followed by a key release). The action to be initiated by the click input may be triggered on any of the three versions of click events defined above as determined by the implementation of a specific embodiment.

In addition, input components may also exhibit a bistate behavior wherein clicking on the input component once transitions it to a clicked state in which it continues to remain. If the input component is clicked again, the input component is returned to its default or unclicked state. This bistate behavior is termed “toggle” in the context of this description.

In the context of this description, the term “click hold” is used to refer to a user input on the user interface that has an extended temporal duration. For example, the user may click on a key or button integrated into the cameraphone and hold it in its clicked state or the user may click on a joystick integrated into the cameraphone and hold it in its clicked state or the user may flick a joystick integrated into cameraphone 1120 and hold it in its flicked state or the user may spin or click a scroll wheel, thumb wheel or equivalent and hold the wheel in its engaged state or the user may input a single input on a touch sensitive or pressure sensitive input component and continue the input in an uninterrupted manner.

The end of the click hold operation, and hence the duration of the click hold event, is marked by the return of the input component to its default or unclicked state. The action to be initiated by the click hold input may be triggered either at the transition of a key from its default state to its clicked state, after the user holds the input component in its clicked state for a previously specified period of time or on return of the input component from its clicked state to its default state.

The difference between a click and a click hold is that a click represents an instantaneous moment, while a click hold represents a duration of time, with the start and end of the duration marked by the click and the release or return of the input component to its unclicked or default state.

In addition to clicks, click holds and toggles, the motion of the cameraphone by itself may be used to represent input events, in certain embodiments. For instance, in some embodiments, motion tracking and estimation processes are used on the visual imagery captured with the camera to detect the motion of cameraphone 1120 relative to its environment.

In other embodiments, the motion of cameraphone 1120 may be sensed using other motion sensing mechanisms such as accelerometers and spatial triangulation mechanisms such as the Global Positioning System (GPS). Specific patterns in the motion of the cameraphone, thus inferred, are used to represent clicks and click hold events. For instance, unique gestures such as the motion of the cameraphone perpendicular to the plane of the camera sensor, a circular motion of the cameraphone or a quick lateral movement of the cameraphone are detected from the motion sensing mechanisms and used to represent various click and click hold events. In addition, a plurality of such unique gestures may be used to represent a plurality of unique click, click hold and toggle events.

In some embodiments, speech input may also be used to generate commands equivalent to clicks, click holds, and toggles using speech and voice recognition components integrated into the system. Further, speech input may also be used for control cursor, highlighting, selection of items in lists and selection of hyperlinks.

Graphical Widgets, Their Selection and Operation

Clicks, click holds, toggles, and equivalent inputs may optionally be associated with visual feedback in the form of widgets integrated into the user interface. An example of a simple widget integrated into the user interface is a graphical button on the cameraphone's display 1206. In some embodiments, a plurality of such widgets integrated into the user interface may be used in conjunction with an input component, to provide a plurality of functionalities for the input component. For example, a joystick may be used to move a selection cursor between a number of graphical buttons presented on the client display to select a specific mode of operation. Once a specific mode of operation has been selected, the system may present the user interface for the selected mode of operation which may include redefinition of the actions associated with the activation of the various input components used by the system. Effectively, such a graphical user interface enables the functionality of a plurality of “virtual” user interface elements (e.g. graphical buttons) using a single physical user interface component (e.g., joystick).

Using an input component to interact with multiple widgets in a graphical user interface may involve a two step process: 1) a step of selecting a specific widget on the user interface to interact with and 2) a step of activating the widget.

The first step of selecting a widget is performed by pointing at the widget with an “arrowhead” mouse pointer, a cross hair pointer or by moving widget highlights, borders and the like, upon which the widget may transition from the unselected to selected state. Moving the cursor away from a widget may transition it from the selected to unselected state. The second step of activating the widget is analogous to the click or click hold operations described earlier for physical input components.

In the context of this description, the term “widget select” is used to describe one of the following operations: 1) the transitioning of a widget from unselected to selected state, 2) the transitioning of a widget from selected to unselected state, or 3) the transitioning of a widget from unselected to selected state followed by its transitioning from selected to unselected state. The term “widget activate” is used to refer to one of the following operations: 1) the transitioning of a widget from inactive to active state, 2) the transitioning of a widget from active to inactive state, or 3) the transitioning of a widget from inactive to active state followed by its transitioning from active to inactive state. A “widget hold” event may be generated by the transitioning of a widget from inactive to active state and the holding of the widget in its active state for an extended duration of time. The return of the widget to its default or inactive state may mark the end of the widget hold event.

In addition, widgets may optionally exhibit a bistate behavior wherein clicking on the input component once while a widget is selected transitions it to an activated state in which it continues to remain. If the widget which is now in its activated state is selected and the input component clicked again, the widget is returned to its default or inactive state. This bistate behavior is termed “widget toggle.”

Widget activate, widget hold and widget toggle events may be generated by the user using clicks, click holds, toggles and equivalent inputs generated using an input component integrated into cameraphone 1120, in conjunction with widgets selected on the graphical user interface.

The selection of a widget on the user interface may be represented by changes in the visual appearance of a widget, e.g., through use of highlights, color changes, icon changes, animation, drawing of a border around the widget or other equivalent visual feedback, through the use of audio feedback such as sounds or beeps or through tactile feedback such as vibrations. Similarly, the activation of a widget using a widget activate operation or an extended activation of a widget using a widget hold operation may be represented by changes in the visual appearance of a widget, e.g., through use of highlights, color changes, icon changes, animation, drawing of a border around the widget or other equivalent visual feedback, through use of audio feedback such as sounds or beeps or through tactile feedback such as vibrations.

Widget select events may be input using an input component that supports selection between a plurality of widgets such as a mouse, joystick, scroll wheel, thumb wheel, touch pad or cursor control keys. Widget activate, widget toggle and widget hold events may be input using input components such as a mouse, joystick, touch pad, scroll wheel, thumb wheel or hard or soft buttons. In addition, the motion of cameraphone 1120 by itself may be used to control the cursor and generate widget select, widget activate, widget toggle and widget hold events, in certain embodiments.

For instance, in some embodiments, motion tracking or estimation mechanisms may be used on the visual imagery captured with camera 1310 to detect the motion of the cameraphone relative to its environment and used to control the movement of the cursor, i.e., for widget select events. In such an embodiment, the motion of the cursor or the selection of widgets mimics the motion of cameraphone 1120. Specific patterns in the motion of cameraphone 1120, may be used to represent widget activate and widget hold events. For instance, unique gestures such as the motion of cameraphone 1120 perpendicular to the plane of the camera sensor, a circular motion of cameraphone 1120 or a quick lateral movement of cameraphone 1120 may be detected from the motion sensing mechanisms and are used to represent various widget activate and widget hold events. The motion of the cameraphone may also be optionally sensed using other motion sensing mechanisms such as accelerometers and triangulation mechanisms such as the Global Positioning System.

In some embodiments, speech input may also be used to generate commands equivalent to click, click hold, toggle, widget select, widget activate, and widget hold events using speech and voice recognition components integrated into the system.

Equivalency of User Interface Inputs

In some embodiments, clicks may be substituted with a click hold, where the embodiment may interpret the click hold such as to automatically generate a click or toggle event from the click hold user input using various system and environmental parameters. For instance, in some embodiments, upon the start of the click hold input or a toggle, the system may monitor the visual imagery for any changes in the characteristics of the visual imagery such as average brightness and automatically capture a still image when such a change occurs and in the process emulates a click. In some embodiments, upon start of a user input click hold event or a toggle, a system timer may be used to automatically capture a still image after a preset interval or a preset number of video frames and in the process emulate a click.

In some embodiments, a click or toggle may be substituted for a click hold. In this case, the implicit duration of the click hold event represented by a click or toggle may be determined automatically by the system based on various system and environmental parameters as determined by the implementation. Similarly, widget activate, widget toggle, and widget hold operations may also be optionally used interchangeably when used in conjunction with additional system or environmental inputs, as in the case of clicks and click holds.

While the following description describes the operation of embodiments using clicks and click holds, other embodiments may substitute these inputs with toggle, widget select, widget activate, widget toggle, and widget hold operations. For instance, in some embodiments, the selection of a button widget may be interpreted as equivalent to a click. In some embodiments, some user interface inputs may be in the form of spoken commands that are interpreted using speech recognition.

Features of Visual Components of User Interface

A user using the system for accessing information services related to visual imagery first captures live visual imagery or selects it from storage and then requests related information services. Upon capture of visual imagery or its selection from storage, the selected or captured visual imagery may be optionally displayed on the user interface.

In some embodiments, where a single still image is captured with the camera or selected from storage, the still image may be displayed on the user interface. In some embodiments, where a plurality of still images or video sequences or combinations thereof are captured from the camera or selected from stored visual imagery, the visual imagery may be displayed in a tiled layout or as a filmstrip on the user interface. When displaying video sequences in tiled layout or filmstrip form, the video sequence itself is played or a specific frame of the video sequence is displayed as a still image. When the visual imagery is comprised of a plurality of still images or video sequences, in some embodiments, only the first or last still image or video sequence to be captured or selected by the user may be presented on the user interface.

In some embodiments, users may request information services related to selected spatiotemporal regions of the visual imagery. Spatiotemporal regions for which a user requests related information services may be represented in the visual imagery displayed on the user interface using various markers such as icons, highlights, overlays, and timelines to explicitly show the demarcation of the spatiotemporal regions in the visual imagery. For instance, a rectangular region selected by the user in a still image may be represented by a rectangular graphic overlaid on the still image. The selection of a specific spatial region of visual imagery in the form of a video sequence is represented by the embedding of a marker in the spatial region through the duration of the video sequence. Examples of such a marker are a change in the brightness, contrast, or color statistics of the selected region such that it stands out from the rest of the visual imagery.

In some embodiments that use input components in conjunction with selectable widgets on the user interface, the process of selecting a widget on the user interface and widget activating or widget toggling or widget holding using a input component is intended to provide a look and feel analogous to clicking or toggling or click holding respectively on an input component used without any associated user interface widgets. For instance, selecting a widget in the form of a graphical button by moving a cursor in the form of a border around the button using a joystick and activating the widget by clicking on the joystick is a user experience equivalent to clicking on a specific physical button.

Similarly, in some embodiments that use input components in conjunction with selectable widgets on the user interface, the process of requesting information services related to a given visual imagery may require the user to select visual imagery displayed in the form of widgets on the user interface such as a viewfinder, tiled layout or filmstrip as described earlier, and widget activate the visual imagery. Such a process provides a user experience that is analogous to “clicking” on the visual imagery.

Features of Audio Components of User Interface

In some embodiments, the user interface may employ audio cues to denote various events in the system. For instance, the system may generate audio signals (e.g., audio tones, audio recordings) when the user switches between different views, inputs information in the user interface, uses input components integrated into the cameraphone (e.g., click, click hold, toggle), uses widgets integrated into the cameraphone user interface (e.g., widget select, widget activate, widget toggle, widget hold) or to provide an audio rendering of system status and features (e.g., system busy status, updating of progress bar, display of menu options, readout of menu options, readout of information options).

In some embodiments, the system may provide an audio rendering of various information elements obtained by processing the visual imagery. The user may then select segments of the audio rendering that are representative of spatiotemporal regions of the visual imagery for which the user is interested in requesting related information services. This process enables users to request information services related to visual imagery without relying on the visual components of the user interface. Users may mark the segments of audio corresponding to the spatiotemporal regions of the visual imagery they are interested in, using various input mechanisms described earlier.

In some embodiments, the system may provide an audio rendering of the information in various media types (e.g., using a text-to-speech converter) in the information services generated by the system as related to visual imagery. This enables users to browse and listen to the information services without using the visual components of the user interface. This feature in conjunction with the other audio feedback mechanisms presented earlier may enable a user to use all features of the system using only the audio components of the user interface, i.e., without using the visual components of the user interface.

Operation of Exemplary Embodiments

The operation of the system may involve capturing of the visual imagery, requesting of information services related to visual imagery, identification of related information services, providing of related information services, presentation of the related information services, optionally in compact form, selection of one or more information services for presentation optionally in their entirety, and the presentation of the selected information services. The process of requesting related information services may be initiated explicitly by the user through user inputs or triggered automatically by the system or environmental events monitored by the system.

In some embodiments, the request for information services related to visual imagery may be generated by cameraphone 1120 and communicated to system server 1160 over communication network 1140. The system server 1160, upon receiving the request, generates the information services. The process of generating the related information services may involve the generation of a plurality of contexts from the visual imagery, associated metadata, information extracted from the visual imagery, and knowledge derived from knowledgebases. A plurality of information services related to the generated contexts may be identified from a plurality of information service sources or knowledgebases. The information services identified as related to the contexts and hence to the visual imagery may then be presented to the user on the cameraphone.

User interface views integrated into system 1100 may enable users to capture visual imagery, request related information services and interact with the related information services. Users may use the different views of the user interface to perform various functions related to requesting, accessing, and using the information services. Users may interact with the user interface through use of appropriate input components integrated into cameraphone 1120.

In some embodiments, operation of the system may require the use of one view (e.g., camera view) of the user interface for capturing the visual imagery, the use of another view (e.g., index view) for presenting the plurality of information services in compact form and the use of another view (e.g., content view) for the presentation of the information services in their entirety. In some embodiments, in response to a request for information services related to a visual imagery, the system may present a single information service as most relevant to a visual imagery, for instance in the content view, without presenting a plurality of information services.

A user using the system to request information services related to visual imagery may first capture visual imagery or select it from storage and then request related information services. In some embodiments, the system presents the captured visual imagery and then the requested information services. In some other embodiments, information services may be presented as the visual imagery is being captured or retrieved from storage, over an extended period of time. In such embodiments, the visual imagery may have extended time duration as in the case of a video sequence or a sequence of still images. Information services related to the visual imagery may be presented as the visual imagery is being communicated or streamed from the cameraphone to system server and processed by the system server. The information services being presented may also be updated continually as the visual imagery is communicated to the system server.

In some embodiments, the information services provided by the system may be presented independent of the visual imagery, for instance, in a separate view of the user interface from the one used to present the visual imagery. In some embodiments, the information services provided by the system may be presented along with the captured visual imagery, for instance, in the same view of the user interface as the captured visual imagery. In some embodiments, the information services may also be presented such that they augment the captured visual imagery.

In some embodiments, transient information services may be presented between the various steps of system operation. For instance, in some embodiments, transient information services may be presented when the system is busy processing or communicating information. In some embodiments, transient information services may be presented for providing sponsored information services. In some embodiments, transient information services may be presented as an interstitial view between displaying different views of the user interface.

The process of capturing visual imagery and the requesting of related information services may use one of the modes of operation discussed below. While the following modes of operation describe the capture of visual imagery, other associated information such as metadata of the visual imagery and other user and system inputs may also be captured along with the visual imagery and used to provide related information services.

One-Step Mode of Operation

Here, the operation of some embodiments in which a user requests information services related to visual imagery using a single step of inputs is described. The single step may comprise of a set of user inputs that is used for both capturing visual imagery and requesting related information services.

In some embodiments, the single step of inputs may trigger the capture of visual imagery by cameraphone 1120, creation of a request for related information services, communication of the request to system server 1160, identification and generation of the related information services by system server, communication of the information services to the cameraphone and presentation of the information services on the cameraphone user interface.

In some embodiments, a one-step mode of operation may be used to request information services related to a single still image captured using the camera integrated into the cameraphone. Here, the user points the camera integrated into cameraphone 1120 at the scene of interest and inputs a click on an input component. Upon that single user input, visual imagery is captured by the cameraphone and a request for related information services is generated. Optionally, the captured still image may be displayed on the user interface. Then the information services related to the still image obtained from the system server may be presented to the user on the cameraphone user interface.

This one-step mode of operation is analogous to taking a picture using a cameraphone with a single click. In this embodiment, upon the user inputting a single click, a still image is captured and the user is presented one or more related information services as opposed to simple storage of the captured image, as in the case of a camera function. Further, exactly a single click may be required to capture the image and to request related information services in the one-step mode of operation, when the captured visual imagery is in the form of a single still image.

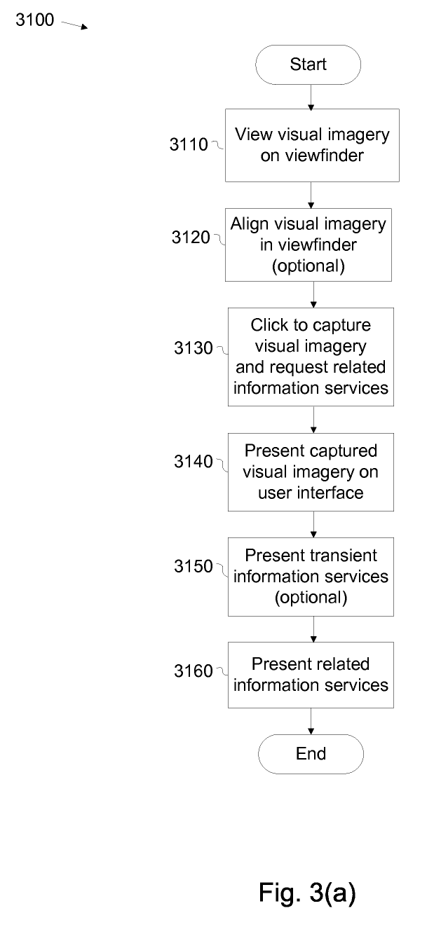

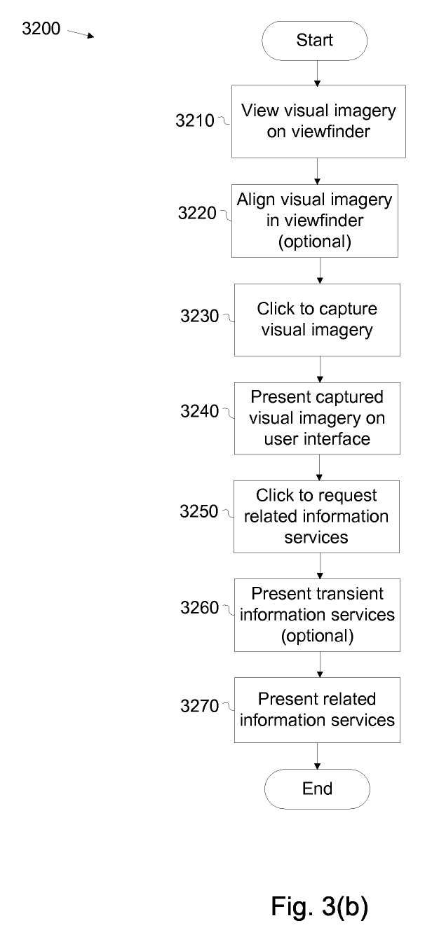

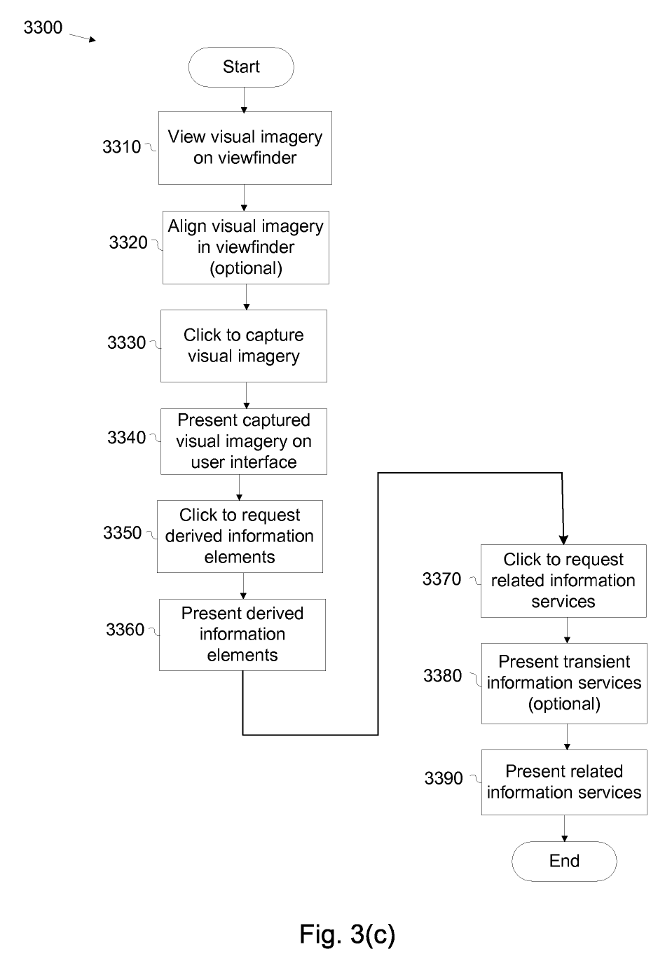

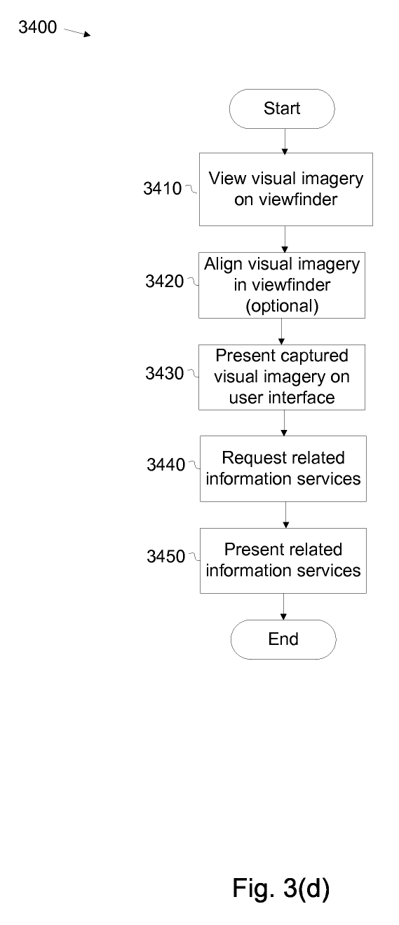

FIG. 3(a) illustrates an exemplary process 3100 for capturing a single still image using camera 1310 integrated into cameraphone 1120 and requesting related information services using a one-step mode of operation. Process 3100 and other processes of this description may be implemented as a set of modules, which may be process modules or operations, software modules with associated functions or effects, hardware modules designed to fulfill the process operations, or some combination of the various types of modules. The modules of process 3100 and other processes described herein may be rearranged, such as in a parallel or serial fashion, and may be reordered, combined, or subdivided in various embodiments.

Here, a user views the visual scene using the viewfinder integrated into the camera view 3110. The user may optionally align the visual imagery displayed in the viewfinder as required in some embodiments 3120. The user then clicks on a joystick to trigger the system to capture a single still image and simultaneously request related information services 3130. The captured still image may optionally be presented in the user interface while the system retrieves related information services 3140. The related information services may be then presented in the index view or content view 3160. In some embodiments, transient information services may be presented before information services related to the visual imagery are presented 3150.

In some embodiments, the one step operation described above for visual imagery comprised of a single still image may be repeated iteratively. In such embodiments, in each cycle of the iteration a single still image may be captured and information services are requested after the capture of the still image. The information services presented in each cycle may be identified and provided based on one or more of the still images captured until that iteration. In this mode of operation, in “N” cycles, the user inputs “N” number of clicks for capturing “N” still images and requesting related information services. This mode of operation helps a user to iteratively filter the obtained information services by providing additional visual imagery input each time.

In some embodiments, a one-step mode of operation may be used to request information services related to a single still image obtained from storage. Here, the user navigates the visual imagery available in storage and selects a still image in order to retrieve information services related to it. The images may be stored in cameraphone 1120 or on system server 1160. In some embodiments, the images available in the system may be presented on the cameraphone user interface with decreased dimensions (i.e., as thumbnails) representative of the images. The user input for the selection of the still image also triggers the request for related information services from the system server. Optionally, the selected still image may be displayed on the user interface. Then the information services related to the still image obtained from the system server may be presented to the user on the cameraphone user interface.

In some embodiments, a one-step mode of operation may be used to request information services related to a contiguous set of still images or a single video sequence captured using the camera integrated into the cameraphone. Here, the user points the camera integrated into the cameraphone at the scene of interest and initiates a click hold on an input component to begin capture of the visual imagery. The system then captures a contiguous set of still images or a video sequence, depending upon the embodiment. Upon termination of the click hold, the visual imagery is used to request related information services. Optionally, the captured visual imagery may be displayed on the user interface. Then the information services related to the visual imagery obtained from the system server may be presented to the user on the cameraphone user interface.

In some embodiments, a one-step mode of operation may be used to request information services related to a single video sequence obtained from storage. Here, the user navigates the visual imagery available in storage and selects a video sequence in order to retrieve information services related to it. The video sequences may be stored in cameraphone 1120 or on system server 1160. In some embodiments, the video sequences available in the system may be presented on the cameraphone user interface with decreased dimensions (i.e., as thumbnails) representative of the video sequences. The user input for the selection of the video sequence also triggers the request for related information services from the system server. Optionally, the selected video sequence may be displayed on the user interface. Then the information services related to the video sequence obtained from the system server may be presented to the user on the cameraphone user interface.

In some embodiments, a one-step mode of operation may be used to request information services related to visual imagery in the form of a plurality of still images, a plurality of video sequences or a combination thereof, captured live from the camera integrated into the cameraphone or obtained from storage. Here, the user captures or selects each of the visual imagery using inputs as discussed earlier. The final user input may also serve as the trigger for request of information services related to the visual imagery. For instance, if the user has not made any additional input for a predetermined duration, the system may interpret the last input as a request for information services related to the set of visual imagery captured or selected so far. In some embodiments, the choice of capturing or selecting visual imagery in the form of a single still image versus a plurality of still images versus a single video sequence versus a plurality of video sequences versus a combination thereof, upon user input, may be automatically made by the system based on parameters such as system timers, user preferences or changes in characteristics of the visual imagery. Further, in the one-step mode of operation, exactly “N” user inputs may be required for requesting information services related to “N” still images captured by a user.

Two-Step Mode of Operation

Here, the operation of some embodiments in which a user requests information services related to visual imagery using two steps of inputs is described. The first step consists of a set of user inputs for capturing visual imagery. The second step consists of a set of user inputs for requesting related information services.

In some embodiments, the first step of operation may trigger the capture of visual imagery by cameraphone 1120. Then, the second step of operation may trigger the creation of a request for related information services, communication of the request to system server 1160, identification and generation of the related information services by system server, communication of the information services to the cameraphone and presentation of the information services on the cameraphone user interface.

In some embodiments, a two-step mode of operation may be used to request information services related to a single still image captured using the camera integrated into the cameraphone. Here, in the first step of operation, the user points the camera integrated into the cameraphone at the scene of interest and inputs a click on an input component to capture a single still image. Optionally, the captured still image may be displayed on the user interface. The user may then request information services related to the still image, in the second step of operation, using an input in the form of a single click. Then the information services related to the still image obtained from the system server may be presented to the user on the cameraphone user interface. Some embodiments may include visual feedback on the user interface such that the captured and displayed visual imagery is highlighted before the user makes the second click. This process in effect creates the user experience of clicking on the captured image.

In some embodiments, using a two-step mode of operation for requesting information services related to a single still image captured using a camera, only two clicks are required—one for capturing the still image and the other for requesting information services.

FIG. 3(b) illustrates an exemplary process 3200 for capturing a single still image using camera 1310 integrated into cameraphone 1120 and requesting related information services using a two-step mode of operation. Here, a user views the visual scene using viewfinder integrated into the camera view 3210. The user may optionally align the visual imagery displayed in the viewfinder as required in some embodiments 3220. The user then clicks on a joystick to trigger the system to capture a single still image 3230. The captured still image may be presented in the user interface in viewfinder 3240. The user then requests related information services with a second click 3250. In some embodiments, transient information services may be presented in the transient information view while the information services related to the visual imagery are being generated by the system 3260. The related information services may be then presented in the index view or content view 3270.

In some embodiments, the two step operation described above for visual imagery comprised of a single still image may be repeated iteratively. In such embodiments, in each cycle of the iteration a single still image may be captured and information services are requested after the capture of the still image. The information services presented in each cycle may be identified and provided based on one or more of the still images captured until that iteration. In this mode of operation, in “N” cycles, the user inputs “N” number of clicks for the first step of capturing the still images and “N” number of clicks for the second step to request related information services. This mode of operation helps a user to iteratively filter the obtained information services by providing additional visual imagery input with each iteration.

In some embodiments, a two-step mode of operation may be used to request information services related to a set of N still images captured using the camera integrated into the cameraphone. Here, in the first step of operation, the user points the camera integrated into the cameraphone at the scenes of interest and inputs N clicks on an input component to capture a set of N still images. Optionally, the captured still images may be displayed on the user interface. The user may then request information services related to the still images, in the second step of operation, using an input in the form of a single click. Then the information services related to the still image obtained from the system server may be presented to the user on the cameraphone user interface. Thus, exactly N+1 inputs are required to request information services related to N still images −“N” clicks for capturing the images and one click for requesting information services.

In some embodiments, a two-step mode of operation may be used to request information services related to a single still image selected from storage. Here, in the first step of operation, the user navigates the visual imagery available in storage and selects a still image. Optionally, the selected still image may be displayed on the user interface. The user may then request information services related to the still image, in the second step of operation using an input in the form of a single click. Then information services related to the still image are obtained from the system server and presented to the user on the cameraphone user interface. This process in effect creates the user experience of interacting with the selected image.

In some embodiments, a two-step mode of operation may be used to request information services related to a contiguous set of still images or a video sequence captured using the camera integrated into the cameraphone. Here, in the first step of operation, the user points the camera integrated into the cameraphone at the scene of interest and inputs a click hold on an input component to capture the visual imagery. The start of the capture of visual imagery may be marked by the transition of the click hold input component to its clicked state and the end of the capture by the return of the click hold input component to its unclicked state. Optionally, the captured visual imagery may be displayed on the user interface. The user may then request information services related to the visual imagery, in the second step of operation, using an input in the form of a single click. Then the information services related to the visual imagery obtained from the system server may be presented to the user on the cameraphone user interface. This process in effect creates the user experience of clicking on the visual imagery.

In some embodiments, a two-step mode of operation may be used to request information services related to a single video sequence selected from storage. Here, in the first step of operation, the user navigates the visual imagery available in storage and selects a video sequence. Optionally, the selected video sequence may be displayed on the user interface. The user may then request information services related to the video sequence, in the second step of operation using an input in the form of a single click. Then information services related to the video sequence are obtained from the system server and presented to the user on the cameraphone user interface. This process in effect creates the user experience of interacting with the video sequence.

In some embodiments, a two-step mode of operation may be used to request information services related to a plurality of still images, a plurality of video sequences, or a combination thereof, captured by a camera integrated into the cameraphone or obtained from storage. Here, in the first step of operation, the user uses clicks and click holds as described earlier to capture or select the visual imagery. Optionally, the visual imagery may be displayed on the user interface. The user may then request information services related to the visual imagery, in the second step of operation using an input in the form of a single click. Then information services related to the visual imagery are obtained from the system server and presented to the user on the cameraphone user interface. This process in effect creates the user experience of interacting with the visual imagery.

Three-Step Mode of Operation

Here, the operation of some embodiments in which a user requests information services related to visual imagery using three steps of inputs is described. The first step consists of a set of user inputs for capturing visual imagery. The second step consists of a set of user inputs for requesting information options. The third step consists of a set of user inputs for requesting information services related to one or more of the information options presented.

In some embodiments, the first step of operation may trigger the capture of visual imagery by cameraphone 1120. Then, the second step of operation may trigger the creation of a request for related information options, communication of the request to system server 1160, identification and generation of the related information options by system server, communication of the information options to the cameraphone and presentation of the information options on the cameraphone user interface. Then, the third step of operation may trigger the creation of a request for information services related to an information option, communication of the request to system server, identification and generation of the related information services by system server, communication of the information services to the cameraphone and presentation of the information services on the cameraphone user interface.

Information options employed in the second step of operation include hotspots, derived information elements, and hyperlinks. Hotspots are spatiotemporal regions of visual imagery that may be demarcated using graphical overlays such as hotspot boundaries, icons, embedded modifications of the visual imagery (e.g., highlighting of hotspots) or through use of audio cues (e.g., the system may beep when a cursor is moved over a hotspot). In some embodiments, the spatiotemporal regions may have spatial dimensions smaller than the spatial dimensions of the visual imagery, e.g., the spatiotemporal regions demarcate a subset of the pixels of the visual imagery. In some embodiments, the spatiotemporal regions may have temporal dimensions that are smaller than the temporal dimensions of the visual imagery, for instance, the spatiotemporal regions may be comprised of a set of adjacent video frames or still images. In some embodiments, the spatiotemporal regions may be demarcated both in spatial and temporal dimensions simultaneously. In some embodiments, hotspots may be presented such that they appear as visual augmentations on the captured visual imagery.

Information elements derived from visual imagery include text strings or other textual, graphical, or audio representations of visual elements extracted from the visual imagery. For instance, embedded textual information extracted from visual imagery may be presented as text strings on the user interface, using icons to denote their location on the visual imagery or be presented through audio output components using speech synthesis. These elements may be presented to the user in the camera view or in the index view as a list or other such representations. For instance, in one embodiment, all the text strings extracted from the visual imagery may be presented as a list in the index view as information options. The user may choose one or more of the presented text strings to obtain related information services. In some embodiments, the captured visual imagery may be presented along with the derived elements. The derived elements may be presented sorted by relevance to the captured visual imagery. Information elements may also be derived by the system based on other inputs, other system information, and system state.

In some embodiments, a three-step mode of operation may be used to request information services related to a single still image captured using the camera integrated into the cameraphone. Here, in the first step of operation, the user points the camera integrated into the cameraphone at the scene of interest and inputs a click on an input component to capture a single still image. Optionally, the captured still image may be displayed on the user interface. The user may then request information options related to the still image, in the second step of operation, using an input in the form of a single click. The information options related to the still image obtained from the system server may then be presented to the user on the cameraphone user interface. The user may then select one or more information options presented and request related information services in the third step of operation. This process in effect creates the user experience of interacting with the captured image.

FIG. 3(c) illustrates an exemplary process 3300 for capturing a single still image using camera 1310 integrated into cameraphone 1120 and requesting related information services using a three-step mode of operation. Here, a user views the visual scene using the viewfinder integrated into the camera view 3310. The user may optionally align the visual imagery displayed in the viewfinder as required in some embodiments 3320. The user then clicks on a joystick to trigger the system to capture a single still image 3330. The captured still image may be presented in the user interface in viewfinder 3340. The user then inputs a second click to request hotspots or derived information elements 3350. The user is then presented with a set of derived elements demarcated on the visual imagery 3360. The user navigates among these derived element options and selects one of them 3370. The user then requests related information services with a third click 3370. In some embodiments, transient information services may be presented in the transient information view while the information services related to the visual imagery are being generated by the system 3380. The related information services may be then presented in the index view or content view 3390.

In the case of requesting information services related to a single still image, the three-step mode of operation may require exactly three clicks: one for capturing the image, one for the generating a list of information options and the last click for requesting information services based on the default information option.

The selection of one or more information options and the requesting of related information services are analogous to selecting and activating one or more widgets on the user interface in terms of the user experience. Hence, all parameters of interaction with widgets in a graphical user interface using a multifunction input component (e.g., use of multifunction input components, the specific types of user's interaction with the multifunction input component, the visual feedback presented on the graphical user interface, use of accelerated key inputs) apply to the user's interaction with the information options.

In some embodiments, a three-step mode of operation may be used to request information services related to a single still image obtained from storage. Here, in the first step of operation, the user navigates the visual imagery available in storage and selects a still image. Optionally, the selected still image may be displayed on the user interface. The user may then request information options related to the still image, in the second step of operation, using an input in the form of a single click. The information options related to the still image obtained from the system server may then be presented to the user on the cameraphone user interface. The user may then select one or more information options presented and request related information services in the third step of operation. This process in effect creates the user experience of interacting with the selected image.

In some embodiments, a three-step mode of operation may be used to request information services related to a set of contiguous still images or single video sequence captured using the camera integrated into the cameraphone. Here, in the first step of operation, the user points the camera integrated into the cameraphone at the scene of interest and inputs a click hold on an input component to capture the visual imagery. Optionally, the captured visual imagery may be displayed on the user interface. The user may then request information options related to the visual imagery, in the second step of operation, using an input in the form of a single click. The information options related to the visual imagery obtained from the system server may then be presented to the user on the cameraphone user interface. The user may then select one or more information options presented and request related information services in the third step of operation. This process in effect creates the user experience of interacting with the captured visual imagery.

In some embodiments, a three-step mode of operation may be used to request information services related to a set of N still images captured using the camera integrated into the cameraphone. Here, in the first step of operation, the user points the camera integrated into the cameraphone at the scenes of interest and inputs N clicks on an input component to capture a set of N still images. Optionally, the captured still images may be displayed on the user interface. The user may then request information options related to the visual imagery, in the second step of operation, using an input in the form of a single click. The information options related to the visual imagery obtained from the system server may then be presented to the user on the cameraphone user interface. The user may then select one or more information options presented and request related information services in the third step of operation. This process in effect creates the user experience of interacting with the N captured still images. With this process, exactly N+2 inputs are required to request information services related to N still images-N clicks for capturing the images, one click for requesting related information options, and one click to request information services related to the default information option.

In some embodiments, a three-step mode of operation may be used to request information services related to a single video sequence obtained from storage. Here, in the first step of operation, the user navigates the visual imagery available in storage and selects a video sequence. Optionally, the selected video sequence may be displayed on the user interface. The user may then request information options related to the video sequence, in the second step of operation, using an input in the form of a single click. The information options related to the video sequence obtained from the system server may then be presented to the user on the cameraphone user interface. The user may then select one or more information options presented and request related information services in the third step of operation. This process in effect creates the user experience of interacting with the selected video sequence.

In some embodiments, a three-step mode of operation may be used to request information services related to a plurality of still images, a plurality of video sequences or a combination thereof, obtained either from storage or captured using a camera integrated into the cameraphone. Here, in the first step of operation, the user captures or selects the visual imagery as described earlier. Optionally, the visual imagery may be displayed on the user interface. The user may then request information options related to the visual imagery, in the second step of operation, using an input in the form of a single click. The information options related to the visual imagery obtained from the system server may then be presented to the user on the cameraphone user interface. The user may then select one or more information options presented and request related information services in the third step of operation. This process in effect creates the user experience of interacting with the visual imagery.

In the embodiments using a three-step mode of operation described above, the information options are generated and presented by the system. In some embodiments employing the three-step mode of operation, the user may define information elements manually. For instance, a user may use inputs from navigational input components to “draw” the demarcation boundaries of a hotspot. Examples of navigational input components include joysticks, trackballs, scroll wheels, thumb wheels, and other components with equivalent functionality. A cursor and cursor control keys or other appropriate input components integrated into cameraphone may also be used to markup the hotspots. Then, the user may request information services related to the manually demarcated hotspot on the visual imagery using a third step, which may involve inputting a single click.

In some embodiments using a three-step mode of operation, the first step and the second step (i.e., capturing visual imagery and generating associated information elements or hotspots) are combined. Hence, this mode of operation may be considered a special case of a two-step mode of operation. The user inputs for the combined first and second steps captures and processes the visual imagery resulting in a list of information options. The user input for the third step, which now is actually the second step, selects one or more information options and requests related information services.

Zero-Input Mode of Operation

Here, embodiments which use zero user inputs for requesting information services related to visual imagery are described. In some embodiments using a zero-input mode of operation, the user points the camera integrated into the cameraphone 1120 at a scene of interest. The visual imagery from the camera may be optionally displayed on the camera view as a viewfinder. As the user points the camera at the visual scene and scans it, cameraphone 1120 may capture still images or video sequences or a combination of both and requests information services related to the captured visual imagery from the system. The choice of capturing still images versus video sequences versus a combination of them and the instant at which to capture the visual imagery and the durations for which to capture the video sequences may be determined by the system based on various system parameters. System parameters used for capturing the visual imagery may include absolute time, a periodic timer event or environmental factors (e.g., ambient lighting, motion in the visual scene or motion of the camera) and the like.

The system identifies and provides information services related to the visual imagery which are then presented automatically without any user input. Optionally, the provided information services may be presented in the form of graphical marks or icons, as an overlay on the visual imagery presented in the viewfinder. In the user's perspective, as the user scans the visual scene with the cameraphone 1120, he may be presented an augmented version of the visual imagery captured by the camera on the viewfinder.

In some embodiments, visual imagery and associated system and environmental information may be captured using a cameraphone 1120 and used to generate a request for related information services without any user input. The request may be communicated to a remote system server 1160 over a communication network 1140. The system server identifies and generates the related information services and communicates the information services to the cameraphone for presentation on the cameraphone user interface. The information services may then be presented as an augmentation of the visual imagery captured earlier. In some embodiments, the information services may be presented as an augmentation of visual imagery being captured and presented live on the viewfinder, with appropriate processing to account for any cameraphone motion i.e., compensation for global motion in the visual imagery caused by camera motion. In some embodiments, the information services may be presented independent of the visual imagery.

FIG. 3(d) illustrates an exemplary process 3400 for capturing a single still image using camera 1310 integrated into cameraphone 1120 and requesting related information services using a zero-input mode of operation. Here, a user views the visual scene using viewfinder integrated into the camera view 3410. The user may optionally align the visual imagery displayed in the viewfinder as required in some embodiments 3420. The cameraphone then automatically captures a single still image and requests related information services from the system 3440. Optionally, the captured still image may be presented in the user interface in viewfinder 3430. The related information services may be then presented in the index view, the content view, or on the camera view as an augmentation of the visual imagery 3450.

In another embodiment using a zero-input mode of operation, the user retrieves and plays back visual imagery stored in cameraphone 1120 or in other components of the system. Upon playback, the cameraphone 1120 automatically selects still images, video sequences or a combination thereof and requests related information services from the system. The related information services provided by the system are then presented to the user on the cameraphone 1120. Optionally, the information services may be presented such that they are integrated with the played back visual imagery for an augmented reality experience.

In this mode of operation, the capture of visual imagery and the requesting of information services related to the visual imagery do not require any explicit user inputs i.e., it is a zero-input mode of operation.

Accelerated User Input

In some embodiments, the user may provide inputs that accelerate the process of providing information services related to visual imagery. In some embodiments, these accelerated user inputs may represent shortcuts to system operations that may otherwise be performed using a plurality of user inputs and operation steps. In some embodiments, these additional inputs may be provided in the final step of the modes of operation described above, such that the system may provide information services accounting for the accelerated user input. In some embodiments, these additional inputs may also be provided after a user is presented the information service such as to help accelerate the process of interacting with information services presented, e.g., limit the information services presented to those from a specific source or database.

The user may perform this additional input by clicking or click holding on one of a plurality of keys integrated into the cameraphone 1120, where each key may be assigned to a particular source or type of information services. For instance, the user may click on a graphical soft button on the display named “WWW” to request related information services only from the World Wide Web. In another embodiment, the user after capturing the visual imagery may click a specific key on the device, say key marked “2” to request information services related to shopping.

In these operations, the system searches or queries only specific databases or knowledgebases as defined in the system, filters the identified information services from them as per the user input, and presents the user with a list of related information services. In some embodiments, a plurality of sources of information services may be mapped to each key. In some embodiments, the user clicks on a plurality of the keys simultaneously or in a specific order to select a plurality of sources or types of information services. Also, in other embodiments, the functionality described above for keys integrated into the cameraphone 1120 may be offered by widgets in the user interface. In some embodiments, the functionality of the keys may be implemented using speech or motion based inputs described earlier.

These accelerated user inputs may provide access to features of the system that otherwise may require multiple user inputs in order to achieve the same results. For instance, in some embodiments, accelerated input options may be available for the commands available in the menus or user preference settings.

Multiple Facets of System Operation

In some embodiments, the system may feature multiple facets of operation. The facets enable a user to select between subsets of features of the system. For instance, a specific facet may feature only a subset of information services provided as related to visual imagery. In other embodiments, a specific facet may feature only a subset of the menu commands available for use. Other examples of facets that may be supported by embodiments include one-step mode of operation, two-step mode of operation, three-step mode of operation, zero input mode of operation, audio supported mode of operation, muted audio mode of operation and augmented user interface mode of operation. In embodiments supporting multiple facets, users may select one among the available set of facets for access to the features of the selected facet. This enables users to use facets i.e., feature sets, appropriate for various use scenarios.

Users may switch between different facets of operation of the system using appropriate user interface elements. For instance, in some embodiments, users may select a specific facet by using a specific input component (e.g., by clicking on a specific key on the key pad) or by activating a specific widget in the user interface (e.g., by selecting and activating a specific icon in the user interface).

In some embodiments, information services may be generated from content available in the World Wide Web. These content are identified and obtained by searching the Web for Web pages with related content. The presentation of such information services may include one or more snippets of the content from the identified Web pages as representative of the content available in its entirety in the Web pages. Such snippets may be generated in real-time at the time of request for information services from the websites or may be previously fetched and stored in the system.

In addition, the information presented may optionally include a headline before the snippets, a partial or complete URL of the Web page and hyperlinks to the source Web pages. The headline may be derived from the title of the associated Web pages or synthesized by interpreting or summarizing the content available in the Web pages. The title or the URL may optionally be hyperlinked to the Web page. The hyperlinks embedded in the information presented enable users to view the Web pages in their entirety if necessary. The user may optionally activate the hyperlink to request the presentation of the Web page in its entirety in a Web browser or on the content view itself.

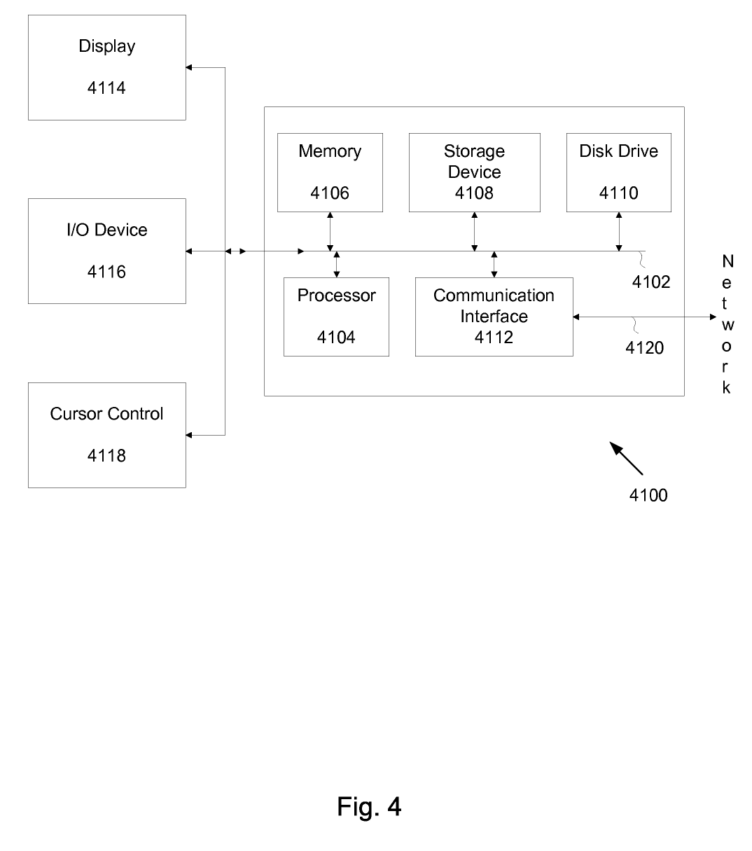

FIG. 4 is a block diagram illustrating an exemplary computer system suitable for providing information services related to visual imagery. In some embodiments, computer system 4100 may be used to implement computer programs, applications, methods, or other software to perform the above described techniques for providing information services related to visual imagery using cameraphones.

Computer system 4100 includes a bus 4102 or other communication mechanism for communicating information, which interconnects subsystems and devices, such as processor 4104, system memory 4106 (e.g., RAM), storage device 4108 (e.g., ROM), disk drive 4110 (e.g., magnetic or optical), communication interface 4112 (e.g., modem or Ethernet card), display 4114 (e.g., CRT or LCD), input device 4116 (e.g., keyboard), and cursor control 4118 (e.g., mouse or trackball).

According to some embodiments, computer system 4100 performs specific operations by processor 4104 executing one or more sequences of one or more instructions stored in system memory 4106. Such instructions may be read into system memory 4106 from another computer readable medium, such as static storage device 4108 or disk drive 4110. In some embodiments, hard wired circuitry may be used in place of or in combination with software instructions to implement the system.

The term “computer-readable medium” refers to any medium that participates in providing instructions to processor 4104 for execution. Such a medium may take many forms, including but not limited to, nonvolatile media, volatile media, and transmission media. Nonvolatile media includes, for example, optical or magnetic disks, such as disk drive 4110. Volatile media includes dynamic memory, such as system memory 4106. Transmission media includes coaxial cables, copper wire, and fiber optics, including wires that comprise bus 4102. Transmission media may also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer may read.

In some embodiments, execution of the sequences of instructions to practice the system is performed by a single computer system 4100. According to some embodiments, two or more computer systems 4100 coupled by communication link 4120 (e.g., LAN, PSTN, or wireless network) may perform the sequence of instructions to practice the system in coordination with one another. Computer system 4100 may transmit and receive messages, data, and instructions, including program, i.e., application code, through communication link 4120 and communication interface 4112. Received program code may be executed by processor 4104 as it is received, and/or stored in disk drive 4110, or other nonvolatile storage for later execution.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method for providing an information service related to a visual imagery using a cameraphone including:
a) capturing of the visual imagery; and
b) requesting of the related information service.

2. The method recited in claim 1, comprising a one step mode of operation, the one step mode of operation including
a) a user inputting a single click for the capturing of the visual imagery and for the requesting of the related information service, wherein the visual imagery is a still image;
b) the method recited in claim 2(a) wherein the capturing of the visual imagery is a capturing of a still image of a live scene.
c) the method recited in claim 2(a) wherein the capturing of the visual imagery is a selecting of a still image from a storage.
d) a user inputting a single click-hold for the capturing of the visual imagery and for the requesting of the related information service, wherein the visual imagery is a video sequence captured live or selected from a storage;
e) the click or click-hold in claim 2(a) through 2(d) being accompanied by a visual feedback;
f) the click or click-hold in claim 2(a) through 2(d) being substituted by a toggle, a widget-select, a widget-activate, a widget-toggle or a widget-hold;
g) the click or click-hold in claim 2(a) through 2(d) being made on the visual imagery displayed on the user interface, either explicitly using a pointing input component such as touch sensitive display or implicitly using a combination of an input component and selection of the visual imagery on a graphical user interface; or
h) the captured visual imagery being displayed along with the resulting information service.

3. The method recited in claim 1, comprising a two step mode of operation, the two step mode of operation including
a) using a single click for capturing the visual imagery in the form of a single still image followed by using a second single click for the requesting of the related information service;
b) using a plurality of user inputs for the selection of the visual imagery in the form of a single still image from stored visual imagery followed by using a single click for the requesting of the related information service;
c) using a click hold for the capture of live visual imagery in the form of a plurality of still images or a video sequence followed by using a second single click for the requesting of the related information service;
d) using a plurality of user inputs for the selection and playback of the visual imagery in the form of a stored video sequence followed by using a user input in the form of a click-hold to select a segment of the video sequence followed by using a single click for the requesting of the related information service;
e) using a plurality of user inputs for the selection and playback of the visual imagery in the form of a stored video sequence followed by using a user input in the form of a plurality of clicks to select a plurality of frames from the visual imagery followed by using a single click for the requesting of the related information service;
f) using a plurality of user inputs for the selection and playback of the visual imagery in the form of a stored video sequence followed by using a user input in the form of a plurality of click-holds to select video sequences from the visual imagery followed by using a single click for the requesting of the related information service;
g) using a plurality of clicks and click-holds to select still image or video frames and video sequences from the captured live visual imagery followed by a single click for the requesting of the related information service;
h) using a plurality of user inputs for the selection and playback of the visual imagery in the form of a stored video sequence followed by using a user input in the form of a plurality of clicks and click-holds to select video frames and video sequences from the visual imagery followed by using a single click for the requesting of the related information service;
i) using a plurality of user inputs for the selection and playback of the visual imagery in the form of a plurality of stored video sequences followed by using a user input in the form of a plurality of clicks to select video frames from the visual imagery followed by using a single click for the requesting of the related information service;
j) using a plurality of user inputs for the selection and playback of the visual imagery in the form of a plurality of stored video sequences followed by using a user input in the form of a plurality of click-holds to select video sequences from the visual imagery followed by using a single click for the requesting of the related information service;
k) using a plurality of user inputs for the selection and playback of the visual imagery in the form of a plurality of stored video sequences followed by using a user input in the form of a plurality of clicks and click-holds to select video frames and video sequences from the visual imagery followed by using a single click for the requesting of the related information service;
l) using an n number of clicks for the capturing of the visual imagery in the form of n number of still images from live visual imagery and using a single click for the requesting of the related information service, wherein n is an integer greater than zero;
m) using an n number of clicks for the capturing of visual imagery and using one click for the requesting of the related information service, wherein the visual imagery is n number of still images in a storage and n is an integer greater than zero;
n) the clicks and click-holds in claims 3(a) through 3(m) being substituted by toggles, widget-selects, widget-activates, widget-toggles or widget-holds;
o) the clicks and click-holds in claims 3(a) through 3(m) being accompanied by a visual feedback; or
p) the click made for requesting the information service in claims 3(a) through 3(m) being made on the visual imagery displayed on the user interface, either explicitly using a pointing input component such as touch sensitive display or implicitly using a combination of an input component and selection of the visual imagery on a graphical user interface.

4. The method recited in claim 1, comprising a three step mode of operation, the three step mode of operation including
a) performing a first step in the form of user inputs for capture or selection of the visual imagery, performing a second step in the form of user inputs for requesting an information option followed by the presenting of the input visual imagery with embedded hotspots;
b) performing a first step in the form of user inputs for capture or selection of the visual imagery, performing a second step in the form of user inputs for requesting an information option followed by the presentation of a list or menu of textual, graphical or audio representation of hotspots;
c) performing a first step in the form of user inputs for capture or selection of the visual imagery, performing a second step in the form of user inputs for requesting an information option followed by the presentation of a list or menu of textual, graphical or audio representation of visual elements recognized from the visual imagery and their permutations and combinations;
d) the method as recited in 4(c) including presenting the captured imagery along with the information options;
e) performing a first step in the form of user inputs for capture or selection of the visual imagery, performing a second step in the form of user inputs for requesting an information option followed by the presentation of a list of hotspots, performing a third step in the form of selecting a hotspot and requesting the related information service, upon which, the related information service is provided;
f) performing a first step in the form of user inputs for capture or selection of the visual imagery, performing a second step in the form of demarcating a spatiotemporal region in the visual imagery and, performing a third step in the form of requesting the related information service, upon which, the related information service is provided;
g) performing a first step in the form of user inputs for capture or selection of the visual imagery, performing a second step in the form of user inputs for requesting an information option followed by the presentation of a list of textual, graphical or audio representations of hotspots, a third step in the form of selecting a hotspot and requesting the related information service upon which the related information service is provided;
h) performing a first step in the form of user inputs for capture or selection of the visual imagery, performing a second step in the form of user inputs for requesting an information option followed by the presentation of a list of textual, graphical or audio representations of visual elements recognized from the image as in 4(c) or 4(d), performing a third step in the form of selecting a hotspot and requesting the related information service upon which the information service is provided;
i) the first two steps of operation, for the capture or selection of visual imagery and the request of related information services, being performed with a single click or click-hold followed by the presentation of a list of hotspots, performing a second step in the form of selecting a hotspot and requesting the related information service upon which related information service is provided;
j) the first two steps of operation, for the capture or selection of visual imagery and the request of related information services, being performed with a single click or click-hold followed by the presentation of a list of textual, graphical or audio representations of elements recognized from the imagery as in 4(c) or 4(d), performing a second step in the form of selecting a hotspot and requesting the information services, upon which, the related information service is provided;
k) using an n number of clicks for the capturing of the visual imagery and two clicks for the requesting of the information service, wherein the visual imagery is in the form of n number of still images, and n is an integer greater than zero;
l) the clicks and click-holds in claims 4(a) through 4(k) being accompanied by a visual feedback;
m) the clicks and click-holds in claims 4(a) through 4(k) being substituted by a toggle, widget-select, widget-activate, widget-toggle or widget-hold;
n) the clicks and click-holds in claims 4(a) through 4(k) being made on the visual imagery displayed on the user interface, either explicitly using a pointing input component such as touch sensitive display or implicitly using a combination of an input component and selection of the visual imagery on a graphical user interface.

5. The method recited in claim 1, using zero user inputs comprising
a) acquiring a live visual imagery or playback of a stored visual imagery;
b) capturing or selecting a still image or a video sequence automatically based on a parameter determined by a system;
c) requesting the information service related to the visual imagery automatically;
d) presenting the related information service embedded into or overlaid on the visual imagery; or
e) presenting the related information service independent of the visual imagery.

6. The method recited in claim 1, including a user input, the user input comprising at least one of:
a) a click;
b) a click-hold;
c) a toggle;
d) a flick; or
e) a cameraphone motion.

7. The method recited in claim 1, including a user interaction using an input component, the input component comprising at least one of:
f) a button;
g) a joystick;
h) a scroll-wheel;
i) a thumb-wheel;
j) a touch sensitive input device; or
k) a pressure sensitive input device.

8. The method recited in claim 1, including using a user input in conjunction with a widget on graphical user interface to perform an operation, the operation including
a) selecting a widget;
b) activating a widget;
c) holding a widget activation; or
d) toggling a widget.

9. The method recited in claim 1, including presenting the visual imagery on a client user interface in the form of
a) a viewfinder;
b) a stored visual imagery playback;
c) a tiled layout of a plurality of visual imagery;
d) a filmstrip layout of a plurality of visual imagery;
e) an excerpt of a visual imagery; or
f) a spatiotemporal region of a visual imagery.

10. The method recited in claim 1, including
a) using a plurality of input components predefined to request information services from a specific source of information services;
b) using a plurality of input components predefined to request information services from a plurality of specific sources of information services;
c) using a plurality of widgets predefined to request information services from a specific source of information services; or
d) using a plurality of widgets predefined to request information services from a plurality of specific source of information services.

11. The method recited in claim 1, including at least one of
a) presenting the information service embedded into the input visual imagery;
b) presenting the information service independent of the input visual imagery;
c) presenting the information service in the form of a list or menu of information service options embedded in the input visual imagery;
d) presenting the information service in the form of a list or menu of information service options independent of the input visual imagery;
e) presenting the information services in a full screen mode;
f) presenting a single information service determined to be most related to the visual imagery;
g) presenting a list of information services with identifiers that qualify the information services with information;
h) presenting a list of information services with hints on whether an information service has been presented to the user in the past;
i) presenting an information service derived from reformatted content sourced from the World Wide Web;
j) presenting of the information service that is reformatted from the source information from which the information services are synthesized through format conversions such as resizing or through media type conversions such as audio to text format;
k) presenting of a sponsored information service before requested related information services are presented to the user;
l) presenting of the information service with optimized color schemes for presentation on the cameraphone.

12. The method recited in claim 1, including presenting the information service that is customized using a parameter, the parameter comprising at least one of a) an explicitly specified user preference;
b) a capability of the cameraphone;
c) a capability of a communication network;
d) a system learned preferences of a user;
e) a media format used in the information services being presented;
f) a sponsored customization;
g) a geographical and spatial location of cameraphone;
h) a time of day; or
i) an ambient lighting around cameraphone.

13. The method recited in claim 1, including presenting of a plurality of options to a user, the option comprising at least one of
a) an information service;
b) a hotspot embedded in the visual imagery;
c) a visual element extracted from the visual imagery;
d) a textual representation of a visual element extracted from the visual imagery;
e) a graphical representation of a visual element extracted from the visual imagery; and
f) a facet of system operation.

14. A system for providing information services related to visual imagery comprising:
a) a cameraphone;
b) a communication network; and
c) a system server.
